(19) United States
(12) Patent Application Publication
(10) Pub. No.: US 2017/0070473 A1
(43) Pub. Date: Mar. 9, 2017

(54) A SWITCHING FABRIC INCLUDING A VIRTUAL SWITCH

(71) Applicant: Hewlett Packard Enterprise Development LP, Houston, TX (US)

(72) Inventors: Michael Schlansker, Palo Alto, CA (US); Jean Tourrilhes, Mountain View, CA (US); Jose Renato G. Santos, Morgan Hill, CA (US); Paul Allen Bottorff, Portola Valley, CA (US)

(21) Appl. No.: 15/119,789

(22) PCT Filed: Mar. 14, 2014
(86) PCT No.: PCT/US2014/028909

§ 371 Date: Aug. 18, 2016

(51) Int. Cl. H04L 29/12; H04L 12/709; H04L 12/64

(52) U.S. Cl. CPC H04L 61/103; H04L 12/6418; H04L 45/245

(57) ABSTRACT

A method may include determining whether a host destination address of a packet received at a particular switch of a switching fabric is associated with a virtual switch address. In response to a determination that the host destination address is associated with the virtual switch address, the method may also include encapsulating the packet with the virtual switch address as a destination fabric address, where the virtual switch address is associated with a virtual switch including a first physical switch and a second physical switch. The method may further include selecting one of the first physical switch and the second physical switch as a routing path. The method may further include routing the packet to the selected physical switch based on the virtual switch address and transmitting the packet from the selected physical switch to a client switch.

### BACKGROUND

Link aggregation control protocol (LACP) is a protocol that enables a combination of physical links between a pair of physical switches. A set of the physical links between the two physical switches is referred to as a link aggregation group (LAG). Traffic transmitted across the LAG is distributed among the set of the physical links by each of the two physical switches.

### BRIEF DESCRIPTION OF THE DRAWINGS

Some examples of the present application are described with respect to the following figures:

FIG. 1 is a block diagram of an example switching fabric including a virtual switch;

FIG. 2 is a block diagram of another example switching fabric including a virtual switch;

FIG. 3 is an example of a flowchart illustrating an example method of transmitting a packet to a switch via a switching fabric including a virtual switch; and

FIG. 4 is a block diagram of an example network device for processing a packet in a switching fabric including a virtual switch.

### DETAILED DESCRIPTION

As described above, traffic, such as packets, transmitted across a link aggregation group (LAG) is distributed among the set of the physical links by each of the two physical switches. However, when a physical switch is connected to a switching fabric, the physical switch may be connected to multiple physical switches of the switching fabric via different physical links (e.g., network ports) of the physical network switch. Thus, complexity of implementing a LAG between a physical switch and a switching fabric is increased.

Examples described herein address the above challenges by providing a switching fabric including a virtual switch that provides a distributed LAG between a physical switch and the switching fabric. For example, a particular physical switch may be connected to a first physical switch of a switching fabric and to a second physical switch of the switching fabric via different links of the particular physical switch. Particular ports of the first physical switch and the second physical switch may form a virtual switch. The first physical switch may be associated with a first physical switch address and a virtual switch address. The second physical switch may be associated with a second physical switch address and the virtual switch address.

When a packet entering the switching fabric is destined for the particular physical switch, the packet may be encapsulated using the virtual switch address. The switching fabric may select one of the first physical switch and the second physical switch based on traffic conditions of the two physical switches. The switching fabric may route the packet to the selected physical switch using the virtual switch address. The selected switch may transmit the packet to the particular physical switch via a LAG. In this manner, examples described herein may reduce complexity of implementing a LAG between a physical switch and a switching fabric.

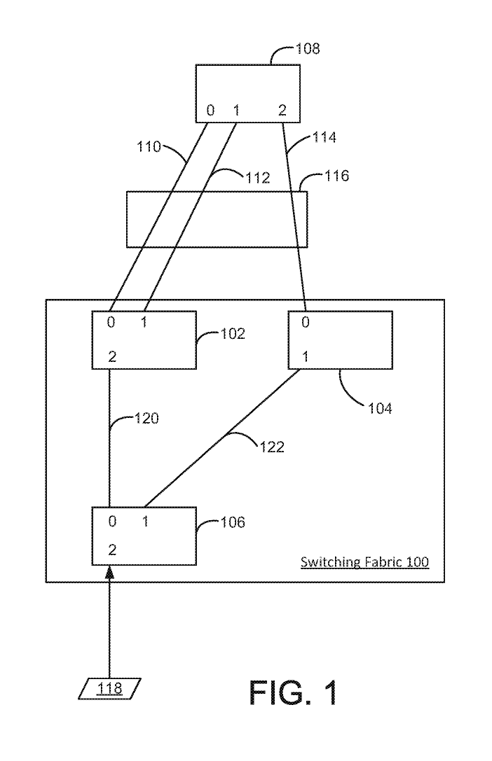

Referring now to the figures, FIG. 1 is a block diagram of an example switching fabric 100 including a virtual switch. As used herein, a switching fabric may be a network device that includes multiple interconnected physical switches. The network device may appear to other network devices as a single entity. Switching fabric 100 may include physical switches 102-106. Each of physical switches 102-106 may be a network device that connects other network devices, such as a computer, another switch, etc., together on a network. Physical switches 102-106 may be interconnected. For example, a port 2 of physical switch 102 may be connected to a port 0 of physical switch 106 via a physical link 120, such as a network cable. A port 1 of physical switch 104 may be connected to a port P1 of physical switch 106 via a physical link 122. Thus, packets may be routed from one of physical switches 102-106 to another of physical switches 102-106.

Switching fabric 100 may implement a media access control (MAC) encapsulation protocol, such as the provider backbone bridging (PBB) protocol or the virtual extensible local area network (VXLAN) protocol, to route packets within switching fabric 100. Each of physical switches 102-106 may be associated with a distinct MAC encapsulation protocol address that is compliant with the MAC encapsulation protocol. For example, when the MAC encapsulation protocol is the PBB protocol, physical switch 102 may be associated with a first physical switch address that corresponds to a first backbone edge bridge (BEB) address. Physical switch 104 may be associated with a second physical switch address that corresponds to a second BEB address. Physical switch 106 may be associated with a third physical switch address that corresponds to a third BEB address. Switching fabric 100 may also implement a hash-based routing protocol, such as the ensemble routing (ER) protocol, to provide efficient multi-path routing. Thus, each of physical switches 102-106 may implement the hash-based routing protocol.

A physical switch 108 may be connected to switching fabric 100 via multiple links. For example, a port 0 of physical switch 108 may be connected to a port 0 of physical switch 102 via a link 110. A port 1 of physical switch 108 may be connected to a port 1 of physical switch 102 via a link 112. A port 2 of physical switch 102 may be connected to a port 0 of physical switch 104 via a link 114. Physical switch 108 may be remote from switching fabric 100. For example, physical switch 108 may not be one of physical switches that form switching fabric 100.

Particular ports of physical switches 102-104 may form a virtual switch 116. Thus, ports 0-1 of physical switch 102 and port 0 of physical switch 104 may correspond to a virtual port useable to communicate with physical switch 108. Virtual switch 116 may be associated with a virtual switch address that is compliant with the MAC encapsulation protocol. For example, when the MAC encapsulation protocol is the PBB protocol, the virtual switch address may correspond to a fourth BEB address. Thus, physical switch 102 may be associated with the first BEB address and the fourth BEB address. Physical switch 104 may be associated with the second BEB address and the fourth BEB address. Physical switch 108 and/or switching fabric 100 may implement the LACP so that links 110-114 may form a LAG. Packets transmitted between physical switch 108 and virtual switch 116 may be distributed across links 110-114 via the LAG in a load balancing manner.

During operation, switching fabric 100 may receive a packet 118 via a port 2 of physical switch 106. Physical switch 106 may receive packet 118 from a network device (not shown in FIG. 1), such as a computer, a switch, etc., connected to physical switch 106. Physical switch 106 may examine packet 118 to determine a routing path of packet 118. For example, physical switch 106 may examine a host destination address of packet 118, such as a destination Internet protocol (IP) address, to determine the routing path based on a routing table. When the host destination address corresponds to a particular network device connected to physical switch 108, physical switch 106 may determine that the routing path of packet 118 includes virtual switch 116. The routing table may indicate that the host destination address of packet 118 is associated with virtual switch 116.

To route packet 118 to virtual switch 116, physical switch 106 may encapsulate packet 118 with the virtual switch address associated with virtual switch 116 as a destination fabric address. For example, physical switch 106 may encapsulate packet 118 with the fourth BEB address as a destination BEB address. Physical switch 116 may also encapsulate packet 118 with the third BEB address as a source fabric address. For example, physical switch may encapsulate packet 118 with the third BEB address as a source BEB address. Based on traffic conditions of physical switches 102-104, physical switch 106 may select one of physical switches 102-104 as a muting path of packet 118. For example, physical switch 106 may select physical switch 102 as the routing path of packet 118. Physical switch 106 may transmit encapsulated packet 118 to physical switch 102 based on the virtual switch address.

When physical switch 102 receives packet 118, physical switch 102 may use a look-up table to determine whether physical switch 102 is the correct recipient of packet 118. The look-up table may indicate at least one BEB address that is associated with physical switch 102. For example, the look-up table may indicate that physical switch 102 is associated with the first BEB address (i.e., the first physical switch address) and the fourth BEB address (i.e., the virtual switch address).

Physical switch 102 may compare the destination BEB address to the at least one BEB address in the look-up table. When the destination BEB address does not match any BEB address in the look-up table, physical switch 102 may determine that physical switch 102 is not the correct recipient of packet 118 and may drop packet 118. When the destination BEB address matches a BEB address in the look-up table, such as the virtual switch address, physical switch 102 may decapsulate the source BEB address and the destination BEB address from packet 118. Physical switch 102 may transmit packet 118 to physical switch 108 via link 110 or link 112 based on the host destination address. Physical switch 108 may transmit packet 118 to the particular network device. Subsequent packets (not shown in FIG. 1) received via physical switch 106 that are destined to the particular network device connected to physical switch 108 may be routed through switching fabric 100 in a similar manner.

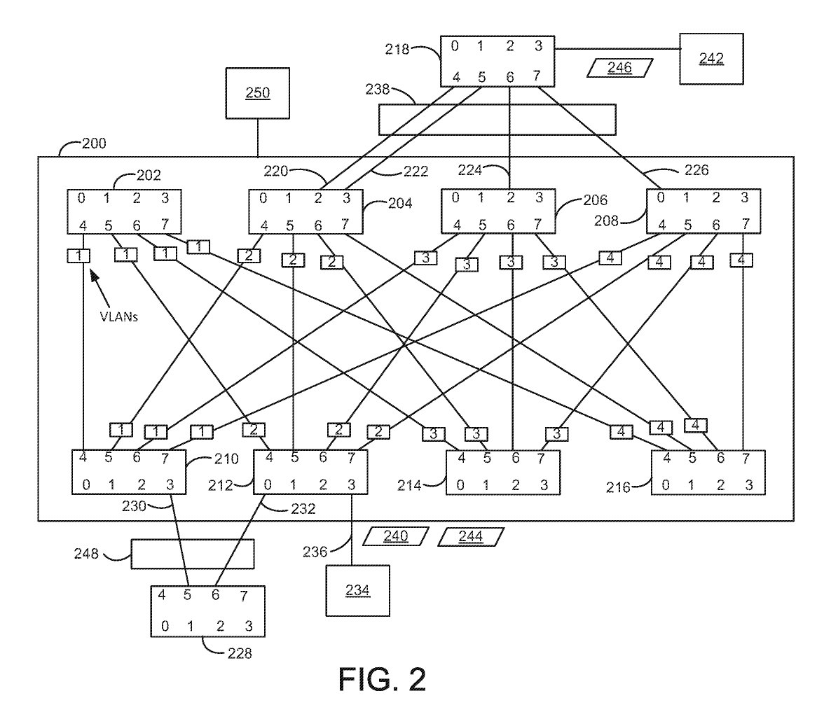

FIG. 2 is a block diagram of another example switching fabric 200 including a virtual switch. Switching fabric 200 may include a plurality of physical switches 202-216. Physical switches 202-216 may be interconnected via Ethernet cables so that any one of physical switches 202-216 may route a packet to another of physical switches 202-216. For example, a port 4 of physical switch 202 may be connected to a port 4 of physical switch 210 and a port 5 of physical switch 210 may be connected to a port 4 of physical switch 204. When physical switch 202 transmits a packet to physical switch 204, physical switch 202 may route the packet to physical switch 204 via physical switch 210 even though physical switch 202 and 204 are not directly connected.

Switching fabric 200 may implement a MAC encapsulation protocol to route packets within switching fabric 200. For example, when the MAC encapsulation protocol is the PBB protocol, each physical switch 202-216 may be associated with a distinct physical switch address that corresponds to a BEB address. Switching fabric 200 may also implement a hash-based routing protocol to provide efficient multi-path routing. For example, when the hash-based routing protocol is the ensemble routing protocol, each physical switch 202-216 may be associated with at least one virtual local area network (VLAN) to route packets.

As an example, when physical switch 202 transmits a packet to physical switch 206, physical switch 202 may route the packet using different VLANs based on traffic conditions of each VLAN. For example, physical switch 202 may route the packet to physical switch 206 via a VLAN 1 or via a VLAN 3. When physical switch 202 routes the packet via the VLAN 1, physical switch 202 may forward the packet to physical switch 210 via the port 4 of physical switch 202. Physical switch 210 may receive the packet via the port 4 of physical switch 210 and forward the packet to physical switch via a port 6 of physical switch 210. When physical switch 202 routes the packet via the VLAN 3, physical switch 202 may forward the packet to physical switch 214 via a port 6 of physical switch 202. Physical switch 214 may receive the packet via a port 4 of physical switch 214 and may forward the packet to physical switch 206 via a port 6 of physical switch 214.

A plurality of network devices, such as computers, switches, routers, etc., that are remote from switching fabric 200 (e.g., not part of switching fabric 200) may be connected to switching fabric 200 via at least one physical switch 202-216 of switching fabric 200. For example, a client switch 218 may be a physical switch connected to switching fabric 200 via physical switches 204-208 via Ethernet cables. Ports 4-5 of client switch 218 may be connected to ports 2-3 of physical switch 204 via links 220-222, respectively, a port 6 of client switch 218 may be connected to a port 2 of physical switch 206 via a link 224, and a port 7 of client switch 218 may be connected to a port 0 of physical switch 208 via a link 226. As another example, a client switch 228 may be a physical switch connected to switching fabric 200 via physical switches 210-22. A port 5 of physical switch 220 may be connected to a port 3 of physical switch 210 via a link 230 and a port 6 of physical switch 220 may be connected to a port 0 of physical switch 212 via a link 232. As another example, a client device 234, such as a computer, may be connected to switching fabric 200 via a port 3 of physical switch 212 via a link 236. Links 220-226, 230-232, and 236 may be physical connections, such as Ethernet cables.

Client switch 218 and/or switching fabric 200 may implement the LACP so that links 220-226 may form a first LAG. Packets transmitted between client switch 218 and switching fabric 200 may be distributed across links 220-226 via the first LAG in a load balancing manner. Client switch 228 may also form a second LAG with switching fabric 200 using links 230-232.

Particular ports of physical switches 204-208 may form a first virtual switch 238. For example, ports 2-3 physical switch 204, port 2 of physical switch 206, and port 2 of physical switch 208 may form first virtual switch 238. First virtual switch 238 may be associated with a first virtual switch address that is compliant with the MAC encapsulation protocol. For example, when the MAC encapsulation protocol is the PBB protocol, the first virtual switch address may correspond to a particular BEB address. Thus, each physical switch 204-208 may be associated with a distinct physical switch address and the first virtual switch address. For example, physical switch 204 may be associated with a first physical switch address corresponding to a first BEB address and the first virtual switch address corresponding to a second BEB address. Physical switch 206 may be associated with a second physical switch address corresponding to a third BEB address and the first virtual switch address corresponding to the second BEB address. Physical switch 208 may be associated with a third physical switch address corresponding to a fourth BEB address and the first virtual switch address corresponding to the second BEB address.

During operation, client device 234 may transmit a packet 240 to physical switch 212 via a port 3 of physical switch 212. Physical switch 212 may examine a host destination address of packet 240, such as a destination IP address or a destination MAC address, to determine a routing path of packet 240 based on a routing table. When the routing table indicates that the destination host address is associated with a client device 242 connected to a port 3 of client switch 218, physical switch 212 may determine that the routing path includes virtual switch 238. The routing table may also indicate that first switch 238 is associated with physical switches 204-208.

To route packet 240 to virtual switch 238, physical switch 212 may encapsulate packet 240 with the first virtual switch address associated with virtual switch 238, such as the second BEB address, as a destination fabric address. The destination fabric address may indicate a switch within switching fabric 200 that is to receive packet 240. The destination fabric address may correspond to a BEB destination address. Physical switch 212 may encapsulate packet 240 with a physical switch address associated with physical switch 212 as a source fabric address. The source fabric address may indicate a switch within switching fabric 200 that is to transmit packet 240. The source fabric address may correspond to a BEB source address.

Based on traffic conditions associated with physical switches 204-208, such as traffic conditions of VLANs associated with physical switches 204-208, physical switch 212 may select one of physical switches 204-208 as the routing path. For example, the VLAN 2 may have less traffic load than the VLANs 1, 3, and 4, thus physical switch 212 may select physical switch 204 as the routing path as physical switch 212 may access physical switch 204 via the VLAN 2. Thus, physical switch 212 may route packet 240 to physical switch 204 using the VLAN 2.

When physical switch 204 receives packet 240, physical switch 204 may use a look-up table to determine whether physical switch 204 is the correct recipient of packet 240. The look-up table may indicate at least BEB address that is associated with physical switch 204. For example, the look-up table may indicate that physical switch 204 is associated with the first BEB address (i.e., the first physical switch address) and the second BEB address (i.e., the first virtual switch address).

Physical switch 204 may compare the destination fabric address to the at least one BEB address in the look-up table. When the destination fabric address does not match any BEB address in the look-up table, physical switch 204 may determine that physical switch 204 is not the correct recipient of packet 240 and may drop packet 240. When the destination fabric address matches any BEB address in the look-up table, such as the second BEB address, physical switch 204 may decapsulate the source fabric address and the destination fabric address from packet 240. Physical switch 204 may transmit packet 240 to client switch 218 via the first LAG, such as link 220 or link 222. Client switch 218 may transmit packet 240 to client device 242 based on the host destination address. Subsequently, client device 234 may transmit a packet 244 to client device 242. Physical switch 212 may encapsulate packet 244 in a similar manner as packet 240. Physical switch 212 may transmit packet 244 to physical switch 206 or physical switch 208 instead of physical switch 204 based on traffic conditions of physical switches 204-208. Physical switch 206 or physical switch 208 may process packet 244 in a similar manner as physical switch 204 processing packet 240 and forward packet 244 via the first LAG to client device 242.

Client device 242 may transmit a packet 246 to client device 234 as a reply packet. Client device 242 may transmit packet 246 to client switch 218. Client switch 218 may transmit packet 246 to first virtual switch 238 via the first LAG. Thus, physical switch may transmit packet 246 to physical switch 204, physical switch 206, or physical switch 208 in a load balancing manner. For example, when there is heavy traffic on links 220-224, client switch 218 may transmit packet 246 to physical switch 208 via link 226 in the first LAG. As another example, when there is heavy traffic on links 224-226, client switch 218 may transmit packet 246 to physical switch 204 via link 220 or link 222.

When first virtual switch 238 receives packet 246, packet 246 may be encapsulated with the first virtual switch address as a source fabric address regardless of which of physical switch 204-208 receives packet 246. For example, client switch 218 may transmit packet 246 to physical switch 204, physical switch 204 may encapsulate packet 246 with the first virtual switch address as a source fabric address and a physical switch address associated with physical switch 212 as a destination fabric address. Client switch 218 may select a VLAN to transmit packet 246 to physical switch 212 based on traffic conditions of VLANs 1-4. When physical switch 212 receives packet 246 from virtual switch 238, physical switch 212 may decapsulate the source fabric address and the destination fabric address from packet 246. Physical switch 212 may transmit packet 246 to client device 234.

Switching fabric 200 may include a plurality of virtual switches. For example, in addition to first virtual switch 238, switching fabric 200 may also include a second virtual switch 248. Physical switches 210-212 may form second virtual switch 248. Links 230-232 between client switch 228 and second virtual switch 248 may form a second LAG. Second virtual switch 248 may process packets transmitted to or received from client switch 228 in a similar manner as first virtual switch 238 processing packets 240-246.

Physical switches 202-216 may implement a learning function to determine information associated with a virtual switch, such as routing information, physical switches that form a virtual switch, etc. For example, when a destination switch, such as physical switch 212, receives a packet from a virtual switch, such as first virtual switch 238, the physical switch may determine whether that a source fabric address is a virtual switch address or a physical switch address. A virtual switch address may have a particular format that can be used to differentiate the virtual switch address from a physical switch address. For example, a virtual switch address may start with a particular prefix and a physical switch address may start another prefix.

When the destination switch identifies a virtual switch address, the destination switch may extract a destination host address in the packet and associates the destination host address with the source fabric address in a look-up table, such as a routing table. The look-up table may also identify a routing path of the packet from the virtual switch to the destination switch. Thus, the destination switch may transmit subsequent packets to the virtual switch using the routes stored in the look-up table that are associated with the virtual switch. When the destination switch updates a look-up table, the physical switch may transmit the updates in a teaching message to physical switches that form a virtual switch.

A teaching message may include a single host address or a list of host addresses from a look-up table of a destination switch. When a destination switch learns an association between a virtual switch to a client device connected to the destination switch, the destination switch may transmit a teaching message including information of the newly learned association to each physical switch that forms the virtual switch.

A physical switch may periodically remove entries after a time-out period to release table space when the entries are not active and to erase entries that are no longer current due to a client device moving from one physical switch to another physical switch. Entries may be periodically refreshed via a teaching message to maintain an active status. When an entry is refreshed, a time-out period associated with the entry may be reset. In some examples, each physical switch in a switching fabric may perform the learning function with a delay that is less than a BEB timeout period, erasure of entries in a look-up table may be postponed.

Switching fabric 200 may also include a fabric manager 250. Fabric manager 250 may maintain global information about switching fabric 200, such as topology of switching fabric 200, routing tables in physical switches 202-216, VLAN structures of switching fabric 200, virtual switch associations (e.g., which physical switches form a virtual switch), or a combination thereof. Fabric manager 250 may provide information to each physical switch 202-216 that describes structures of virtual switches (e.g., which ports from multiple physical switches form a virtual switch). Fabric manager 250 may also provide routing information to each physical switch 202-216 that describes how packets should be sent to a virtual switch. Fabric manager 250 may monitor traffic conditions of VLANs 1-4 of switching fabric 200. In some examples, fabric manager 250 may be implemented on a computer that is connected to switching fabric 200. In some example, fabric manager 250 may be implemented on a physical switch of switching fabric 200.

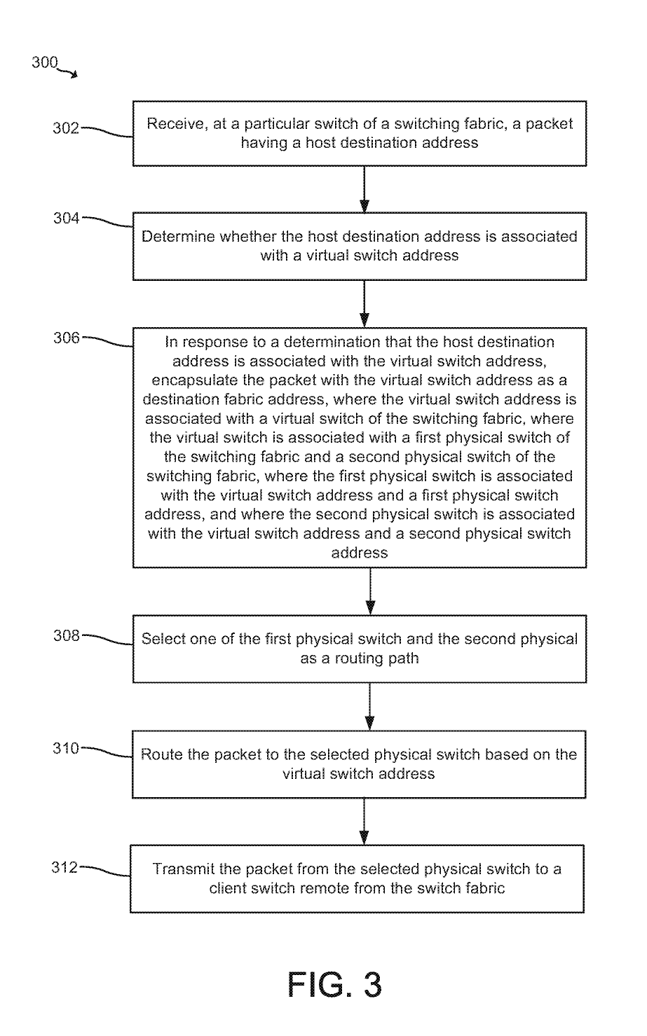

FIG. 3 is an example of a flowchart illustrating an example method 300 of transmitting a packet to a switch via a switching fabric including a virtual switch. Method 300 may be implemented by switching fabric 100 of FIG. 1 or switching fabric 200 of FIG. 2. Method 300 includes receiving, at a particular switch of a switching fabric, a packet having a first host destination address, at 302. For example, referring to FIG. 1, switching fabric 100 may receive a packet 118 via a port 2 of physical switch 106.

Method 300 also includes determining whether the host destination is associated with a virtual switch address, at 304. For example, referring to FIG. 1, physical switch 106 may examine a host destination address of packet 118, such as a destination Internet protocol (IP) address, to determine the routing path based on a routing table. In response to a determination that the host destination address corresponds to a particular network device connected to physical switch 108, physical switch 106 may determine that the routing path of packet 118 includes virtual switch 116. The routing table may indicate that the host destination address of packet 118 is associated with virtual switch 116.

Method 300 further includes In response to a determination that the host destination address is associated with the virtual switch address, encapsulating the packet with the virtual switch address as a destination fabric address, where the virtual switch address is associated with a virtual switch of the switching fabric, where the virtual switch is associated with a first physical switch of the switching fabric and a second physical switch of the switching fabric, where the first physical switch is associated with the virtual switch address and a first physical switch address, and where the second physical switch is associated with the virtual switch address and a second physical switch address, at 306. For example, referring to FIG. 1, To route packet 118 to virtual switch 116, physical switch 106 may encapsulate packet 118 with the virtual switch address associated with virtual switch 116 as a destination fabric address. For example, physical switch 106 may encapsulate packet 118 with the fourth BEB address as a destination BEB address. Physical switch 116 may also encapsulate packet 118 with the third BEB address as a source fabric address. For example, physical switch may encapsulate packet 118 with the third BEB address as a source BEB address.

Method 300 further includes selecting one of the first physical switch and the second physical as a routing path, at 308. For example, referring to FIG. 1, b on traffic conditions of physical switches 102-104, physical switch 106 may select one of physical switches 102-104 as a routing path of packet 118. Method 300 further includes routing the packet to the selected physical switch based on the first virtual switch address, at 310. For example, referring to FIG. 1, physical switch 106 may transmit encapsulated packet 118 to physical switch 102 based on the virtual switch address. Method 300 further includes transmitting the packet from the selected physical switch to a client switch remote from the switching fabric, at 312. For example, referring to FIG. 1, physical switch 102 may transmit packet 118 to physical switch 108 via link 110 or link.

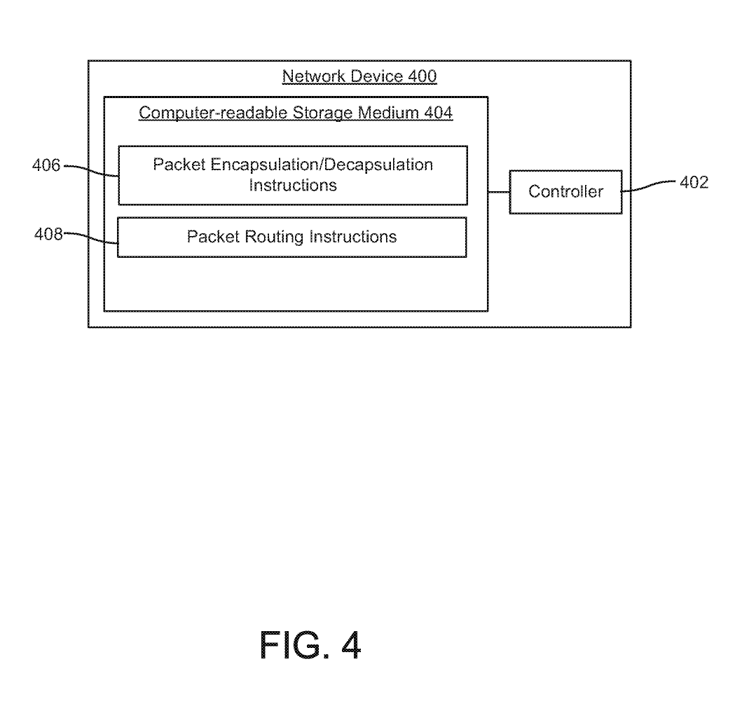

FIG. 4 is a block diagram of an example network device 400 for processing a packet in a switching fabric including a virtual switch. Network device 400 may be implemented as a switch of a switching fabric, such as physical switch 102 of switching fabric 100 of FIG. 1. Network device 400 may be an electronic device suitable for routing packets. Network device 400 may include a controller 402 and a computer-readable storage medium 404.

Controller 402 may be a processor, a central processing unit (CPU), a semiconductor-based microprocessor, and/or other hardware devices suitable for retrieval and execution of instructions stored in computer-readable storage medium 404. Controller 402 may fetch, decode, and execute instructions 406-408 to control a process of routing a packet in a switching fabric including a virtual switch. As an alternative or in addition to retrieving and executing instructions, controller 402 may include at least one electronic circuit that includes electronic components for performing the functionality of instructions 406, 408, or a combination thereof.

Computer-readable storage medium 404 may be any electronic, magnetic, optical, or other physical storage device that contains or stores executable instructions. Thus, computer-readable storage medium 404 may be, for example, Random Access Memory (RAM), an Electrically Erasable Programmable Read-Only Memory (EEPROM), a storage device, an optical disc, etc. In some examples, computer-readable storage medium 404 may be a non-transitory storage medium, where the term “non-transitory” does not encompass transitory propagating signals. As described in detail below, computer-readable storage medium 404 may be encoded with a series of processor executable instructions 406-408 for encapsulating/decapsulating a packet and routing a packet via a switching fabric including a virtual switch.

Packet encapsulation/decapsulation instructions 406 may encapsulate or decapsulate a packet with an address of a switch in a switching fabric. The address may be a physical switch address that is compliant with a MAC encapsulation protocol, such as the PBB protocol, the VXLAN protocol. The address may also be a virtual switch address that is with the MAC encapsulation protocol. Packet routing instructions 408 may route a packet via the switching fabric. Packet routing instructions 408 may route a packet using either a physical switch address or a virtual switch address to a switch within a switching fabric. Packet routing instructions 408 may also route a packet using a host destination address of a client computing device.

The use of “comprising”, “including” or “having” are synonymous and variations thereof herein are meant to be inclusive or open-ended and do not exclude additional unrecited elements or method steps.

What is claimed is:

1. A method comprising:
receiving, at a particular switch of a switching fabric, a packet having a host destination address;
determining whether first host destination address is associated with a virtual switch address; and
in response to a determination that the host destination address is associated with the virtual switch address:
encapsulating the packet with the virtual switch address as a destination fabric address, wherein the virtual switch address is associated with a virtual switch of the switching fabric, wherein the virtual switch is associated with a first physical switch of the switching fabric and a second physical switch of the switching fabric, wherein the first physical switch is associated with the virtual switch address and a first physical switch address, and wherein the second physical switch is associated with the virtual switch address and a second physical switch address;
selecting one of the first physical switch and the second physical switch as a routing path;
routing the packet to the selected physical switch based on the virtual switch address; and
transmitting the first packet from the selected physical switch to a client switch remote from the switching fabric.

2. The method of claim 1, further comprising, in response to a determination that the host destination address is associated with the first physical switch address:
encapsulating the packet with the first physical switch address as the destination fabric address;
routing the packet to the first physical switch based on the first physical switch address; and
transmitting the packet from the first physical switch to the switch based on the host destination address.

3. The method of claim 1, wherein the packet is received from a second client switch associated with a second host destination address, further comprising:
receiving, at the first physical switch, a second packet from the client switch via a link aggregation group (LAG), wherein the second packet includes the second host destination address;
encapsulating the second packet with the virtual switch address as a source fabric address;
routing the second packet to the particular switch based on a particular destination fabric address associated with the particular switch;
receiving, at the second physical switch, a third packet from the client switch via the LAG, wherein the third packet includes the second host destination address;
encapsulating the third packet with the virtual switch address as the source fabric address; and
routing the third packet to the particular switch based on the particular destination fabric address.

4. The method of claim 1, wherein the selected physical switch is selected based on traffic conditions of the first physical switch and the second physical switch, and wherein the traffic conditions are monitored via a fabric manager connected to the switching fabric.

5. The method of claim 1, wherein the packet is encapsulated based on a media access control (MAC) encapsulation protocol.

6. The method of claim 5, wherein the MAC encapsulation protocol includes a provider backbone bridging (PBB) protocol or a virtual extensible local area network (VXLAN) protocol.

7. The method of claim 1, wherein the packet is routed based on an ensemble routing (ER) protocol.

8. An apparatus comprising:
a switching fabric having a plurality of switches, wherein the plurality of switches includes a particular switch, a first physical switch, and a second physical switch, the switching fabric to:
receive, at the particular switch, a packet having a host destination address;
determine whether the host destination address is associated with a virtual switch address; and
in response to a determination that the host destination address is associated with the virtual switch address:
encapsulate the packet with the virtual switch address based on a media access control (MAC) encapsulation protocol, wherein the virtual switch address is associated with a virtual switch of the switching fabric, wherein the virtual switch is associated with the first physical switch and the second physical switch, wherein the first physical switch is associated with the virtual switch address and a first physical switch address, and wherein the second physical switch is associated with the virtual switch address and a second physical switch address;
select one of the first physical switch and the second physical switch as a routing path;
route the packet to the selected physical switch based on the virtual switch address; and
transmit the packet from the selected physical switch to a client switch remote from the switching fabric.

9. The apparatus of claim 8, wherein, in response to a determination that the host destination address is associated with the first physical switch address, the switching fabric further to:
encapsulate the packet with the first physical switch address as a destination fabric address;
route the packet to the first physical switch based on the first physical switch address; and
transmit the packet from the first physical switch to the switch based on the host destination address.

10. The apparatus of claim 8, wherein the packet is received from a second client switch associated with a second host destination address, wherein the switching fabric further to:
receive, at the first physical switch, a second packet from the client switch via a link aggregation group (LAG), wherein the second packet includes the second host destination address;
encapsulate the second packet with the virtual switch address as a source fabric address;
route the second packet to the particular switch based on a particular destination fabric address associated with the particular switch;
receive, at the second physical switch, a third packet from the client switch via the LAG, wherein the third packet includes the second host destination address;
encapsulate the third packet with the virtual switch address as the source fabric address; and
route the third packet to the particular switch based on the particular destination fabric address.

11. The apparatus of claim 8, wherein the switching fabric to select the selected physical switch based on traffic conditions of the first physical switch and the second physical switch, and wherein a fabric manager connected to the switching fabric to monitor the traffic conditions.

12. The apparatus of claim 8, wherein the MAC encapsulation protocol includes a provider backbone bridging (PBB) protocol or a virtual extensible local area network (VXLAN) protocol.

13. A non-transitory computer-readable storage medium comprising instructions that when executed cause a controller of a network device to:
receive, at a particular switch of a switching fabric, a packet having a host destination address;
determine whether the host destination address is associated with a virtual switch address; and
if the host destination address is associated with the virtual switch address:
encapsulate the packet with the virtual switch address as a destination fabric address, wherein the virtual switch address is associated with a virtual switch of the switching fabric, wherein the virtual switch is associated with a first physical switch of the switching fabric and a second physical switch of the switching fabric, wherein the first physical switch is associated with the virtual switch address and a first physical switch address, and wherein the second physical switch is associated with the virtual switch address and a second physical switch address;
select one of the first physical switch and the second physical switch as a routing path;
route the packet to the selected physical switch based on the virtual switch address and based on an ensemble routing (ER) protocol; and
transmit the first packet from the selected physical switch to a client switch remote from the switching fabric.

14. The computer-readable storage medium of claim 13, wherein, in response to a determination that the host destination address is associated with the first physical switch address, the instructions when executed further cause the controller of the network device to:
encapsulate the packet with the first physical switch address as the destination fabric address;
route the packet to the first physical switch based on the first physical switch address; and
transmit the packet from the first physical switch to the client switch based on the host destination address.

15. The computer-readable storage medium of claim 13, wherein the packet is received from a second switch associated with a second host destination address, wherein the instructions when executed further cause the controller to:
receive, at the first physical switch, a second packet from the client switch via a link aggregation group (LAG), wherein the second packet includes the second host destination address;
encapsulate the second packet with the virtual switch address as a source fabric address;
route the second packet to the particular switch based on a particular destination fabric address associated with the particular switch;
receive, at the second physical switch, a third packet from the client switch via the LAG, wherein the third packet includes the second host destination address;
encapsulate the third packet with the virtual switch address as the source fabric address; and
route the third packet to the particular switch based on the particular destination fabric address.
